(19) United States
(12) Patent Application Publication
(10) Pub. No.: US 2005/0196249 A1
(43) Pub. Date: Sep. 8, 2005

(54) Hinge fastening apparatus

(76) Inventor: Ting-Tsai Huang, Kaohsiung Hsien (TW)

Correspondence Address: BIRCH STEWART KOLASCH & BIRCH, PO BOX 747, FALLS CHURCH, VA, 22040-0747, US

(21) Appl. No.: 10/790,789

(22) Filed: Mar. 3, 2004

(51) Int. Cl. F16B 13/04

(52) U.S. Cl. 411/60.1

(57) ABSTRACT

A hinge fastening apparatus includes an inner stem housed in an outer sleeve to run through a hinge body, and an actuating plate located outside the hinge body. The inner stem has a straight stem section and a conical stem section to couple with a straight bore section and a conical bore section of the outer sleeve. The inner stem runs through the outer sleeve to pivotally couple with the actuating plate. The pivotal section of the actuating plate forms a cam section. The coupling portion of the outer sleeve and the inner stem is located on the installation side of the hinge body and the furniture. The actuating plate bucks on the outer surface of the hinge body in a tilted manner and pulls the inner stem to expand the outer sleeve to form a rapid and tight fastening on the bore.

### FIELD OF THE INVENTION

The present invention relates to a hinge fastening apparatus and particularly to an apparatus for rapidly coupling and fastening a hinge on furniture.

### BACKGROUND OF THE INVENTION

Hinges have been widely used on cabinets and furniture. U.S. Pat. No. 5,561,888 discloses a hinge structure which includes a hinge cup on a pivot end to be wedged in a door frame and fastening flanges extended from two sides of the hinge cup with apertures formed thereon. The fastening flange has a hollow barrel coupler on the inner side made from plastics to couple with bores on the doorframe. The hollow barrel coupler has two sets each, having holes on two sides or connected by a plate. The barrel coupler has slits to facilitate expansion and annular teeth on the outer side to engage tightly with fastening bore of the doorframe. For installation, screws run through the apertures of the fastening flange to couple with the barrel coupler and expand the barrel coupler so that the annular teeth are coupled tightly with the fastening bore of the doorframe. U.S. Pat. No. 5,463,793 also discloses a similar structure. It has clamping jaws on two sides of a housing and a bucking mechanism. The bucking mechanism may be driven by a lid plate above the housing so that once the lid plate covers the housing, the bucking mechanism can push the clamping jaws to wedge tightly in a bore formed on the door frame for fastening. U.S. Pat. No. 5,577,297 discloses another type of hinge that has an eccentric latch bar on the aperture of a fastening flange. The aperture is coupled with a plastic sleeve, which houses the eccentric latch bar. The eccentric bar has protrusive rotary teeth on an inner end and an outer end coupled with a rotary handle. The eccentric latch bar is inserted into a fastening bore of the doorframe. Turning the rotary handle, the eccentric and protrusive rotary teeth on the inner end of the eccentric latch bar may be turned to couple tightly with the fastening bore.

All the conventional hinge structures set forth above use screws, latch members, teeth elements and eccentric teeth for fastening. Fastening by screws is tedious and not suitable for automatic assembly. Using the lid plate of the hinge cup to drive the bucking mechanism, to move the clamping jaws for fastening, involves a complicated structure and results in a higher manufacturing cost. Using the eccentric latch bar and eccentric rotary teeth results in different directions of turning operation and installation of the hinge cup. It requires two-step operations in the automatic production and assembly process. And process time increases. As cabinet or furniture plants generally adopt automatic operation to install the hinge elements on the cabinet panels for mass production so that assembly of the furniture may be faster and more convenient, the conventional hinge structures mentioned above are not desirable for an automatic fabrication process.

Furthermore, U.S. Pat. No. 5,895,103 discloses a fastening device, which is mainly for fastening to the front plate of a drawer. While its basic principle is somewhat similar to the fastening apparatus of the present invention, the present invention mainly focuses on the hinge design and has a greater practicality. The structure of the present invention is novel and provides improved functions over the conventional hinge structures, and allows rapid installation of the hinge.

### SUMMARY OF THE INVENTION

In view of the aforesaid problems, the object of the present invention is to provide a hinge structure for rapid installation and fastening.

In one aspect of the invention, a hinge body is provided and runs through by an inner stem housed in an outer sleeve, and an actuating plate is provided outside the hinge body. The coupling section of the outer sleeve and the inner stem have respectively a straight bore section and a straight stem section that correspond to each other, and a conical bore section and a conical stem section that also correspond to each other. The inner stem has one end running through the outer sleeve to pivotally couple with the actuating plate. The pivotal end of the actuating plate is eccentric from a pivotal pin to form a cam section. The coupling section of the outer sleeve and the inner stem is located on the installation side of the furniture on one side of the hinge body. The cam section of the actuating plate rams the outer surface of the hinge in a tilted manner. After the coupling section of the outer sleeve and the inner stem have been sunk into a bore of the furniture, the actuating plate is depressed to latch and couple. The cam section can pull the inner stem to expand the outer sleeve and compress the bore to form a tight fastening.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the hinge cup of the invention.

FIG. 2 is a fragmentary sectional view of the hinge cup of the invention in an initial coupling condition.

FIG. 3 is a fragmentary sectional view of the hinge cup of the invention in an anchored condition.

FIG. 4 is a fragmentary sectional view of the hinge cup of the invention before the actuating plate is moved.

FIG. 5 is a fragmentary sectional view of the hinge cup of the invention after the actuating plate is moved.

FIG. 6 is an exploded view of another embodiment of the outer sleeve of the invention.

FIG. 7 is an exploded view of another embodiment of the invention with a cartridge-fastening seat.

### DESCRIPTION OF THE PREFERRED EMBODIMENTS

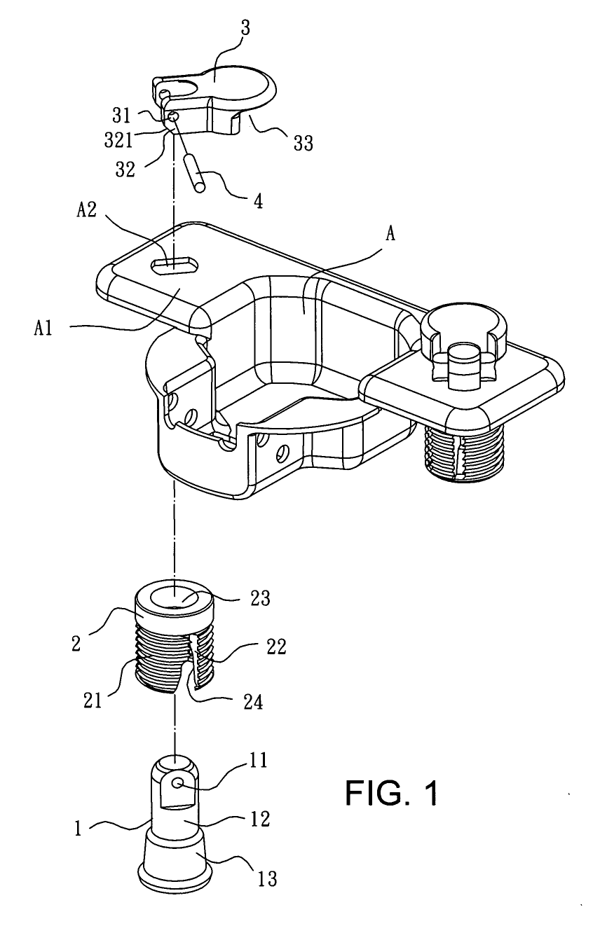

Referring to FIG. 1, the hinge fastening apparatus according to the invention is to couple with a hinge cup A.

The hinge cup A has flanges A1 extending from two sides thereof. On the flanges A1, there are apertures A2 on two sides.

For each flange A1, the apparatus of the invention includes at least an inner stem 1, an outer sleeve 2 and an actuating plate 3. The inner stem 1 has a first pin hole 11 on one end to pivotally couple with the actuating plate 3 through a pin 4. The stem has a straight stem section 12 and a conical stem section 13. The outer sleeve 2 has annular or helical teeth 21 on the outer surface, and a plurality of longitudinal slits 22 formed on the peripheral wall. The hollow interior of the outer sleeve 2 forms a straight bore section 23 and a conical core section 24 to house and couple respectively the straight stem section 12 and the conical stem section 13 of the inner stem 1. The actuating plate 3 has second pinholes 31, to pivotally couple with the inner stem 1 through the pin 4. The actuating plate 3 at the pivotal end forms an eccentric relationship with the pin 4 and forms a cam section 32. The cam section 32 has a corner forming an inverse angle plane 321. The actuating plate 3 has a force applying lever and a recess 33 thereunder, to enable a hand tool to wedge and pry the actuating plate 3.

For assembly, the inner stem 1 runs through the aperture A2 of the flange A1 through one end where the first pin hole 11 is located, with the outer end of the inner stem 1 pivotally coupled with the actuating plate 3 outside the flange A1, and the coupling section of the inner stem 1 and the outer sleeve 2 is located on the inner side of the flange A1, and the inverse angle plane 321 of the cam section 32 is in contact with the surface of the flange A1 so that the actuating plate 3 is tilted upwards.

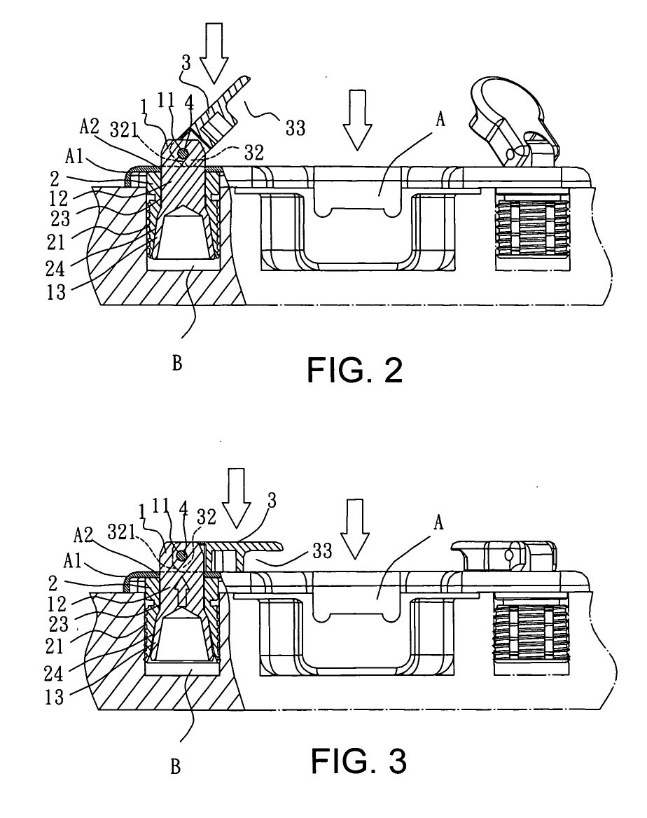

For fastening the hinge cup A to a furniture, referring to FIG. 2, the outer sleeve 2 and the inner stem 1 are sunk into a preset bore B on the furniture. Referring to FIG. 3, the actuating plate 3 is depressed in a direction the same as the installing direction of the hinge cup A, so that the actuating plate 3 is turned and the cam section 32 rams the outer surface of the flange A1. The inner stem 1 is pulled outwards, and the conical stem section 13 pushes and expands the conical bore section 24 of the outer sleeve 2. As a result, the annular teeth 21 of the outer sleeve 4 wedge into the inner wall of the bore B, to form a secure fastening. Therefore, the hinge may be fastened to the desired location rapidly and conveniently. This is a single direction operation.

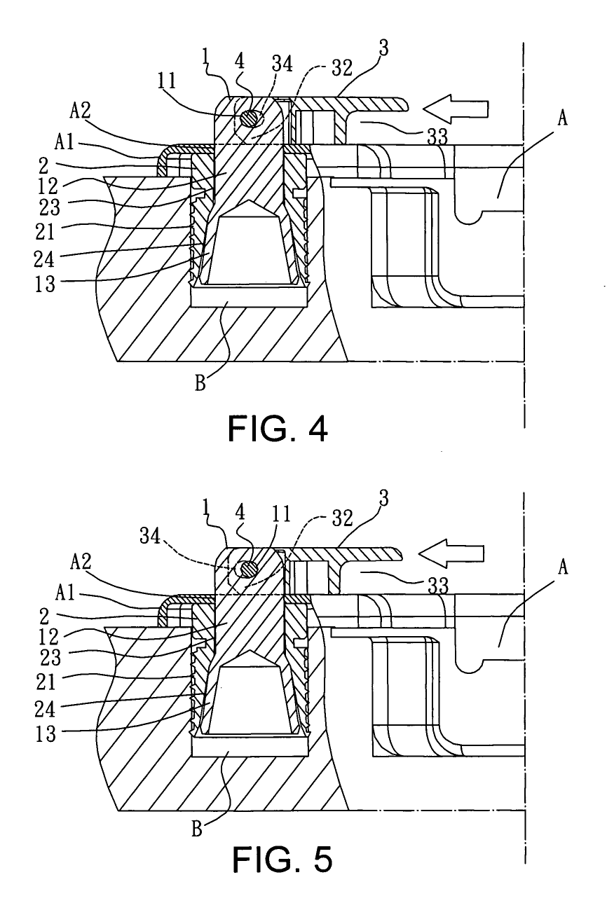

To prevent the actuating plate 3 from being pried upwards mistakenly, a safety measure may be adopted as shown in FIG. 4. The second pin hole 31 on the actuating plate 3 is formed in a slot 34. Referring to FIG. 5, after the actuating plate 3 is coupled on the outer side of the flange A1, move the actuating plate 3 in the direction of the slot 34 to shrink the gap between the pin 4 and the inner stem 1. The restrictive interference against the inverse motion of the actuating plate 3 is greater so that it cannot be pried and moved upwards directly.

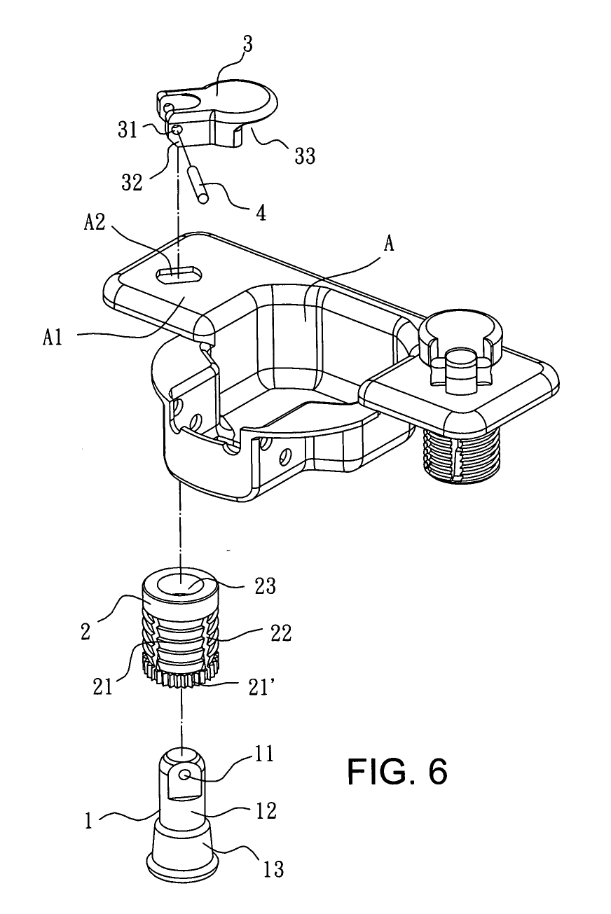

Refer to FIG. 6 for another embodiment of the invention, in order to further enhance the fastening power to the furniture, the monotonous annular teeth 21 on the outer surface of the outer sleeve 2 may be altered to contain ratchet teeth 21 and 21′ of two directions so that they are wedged into the inner wall of the bore of the furniture in a plurality of directions to prevent the outer sleeve 2 from being turned and pulled out, and increase the fastening power.

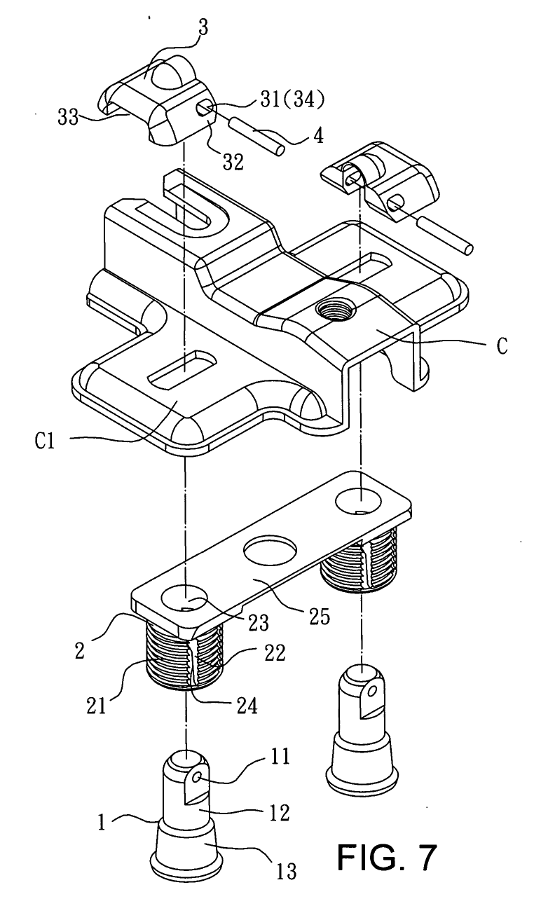

Refer to FIG. 7 for another embodiment of the invention. The hinge has a cartridge fastening seat C. The actuating plate 3 is substantially the same as the one of the previous embodiment. The same numerals are marked for the elements of similar functions. The appearance of the elements is altered to increase appealing. Two outer sleeves 2 are connected by an integrated plate 25 so that they are easily mounted on the inner sides of the flanges C1 on two sides of the cartridge fastening seat C.

1. A hinge fastening apparatus comprising a hinge cup, an inner stem housed in an outer sleeve to run through the hinge cup and to be located on an installation side of the hinge cup, and an actuating plate located on an outer side of the hinge cup, wherein:
the hinge cup has flanges extended from two sides thereof, the flange on each side having an aperture;
the inner stem has a first pin hole on one end to pivotally couple with the actuating plate through a pin, and a straight stem section and a conical stem section;
the outer sleeve has annular teeth on an outer surface, slits formed on the peripheral wall, and a hollow interior which forms a straight bore section and a conical bore section; and
the actuating plate has second pin holes on an eccentric location of one end thereof to couple with the pin, the eccentric end forming a cam section; the actuating plate is bucking on an outer surface of the hinge cup in a tilted manner;
wherein the outer sleeve houses and couples the inner stem, the one end of the inner stem where the first pin hole is located running though the aperture to couple with the actuating plate outside the flange such that the coupling portion of the outer sleeve and the inner stem is located on an inner side of the flange.

2. The hinge fastening apparatus of claim 1, wherein the cam section has an inverse angle plane in contact with the flange so that the actuating plate forms the tilted manner.

3. The hinge fastening apparatus of claim 1, wherein the actuating plate has a force applying lever and a recess formed below the force applying lever to receive a hand tool for prying the actuating plate.

4. The hinge fastening apparatus of claim 1, wherein the second pin holes of the actuating plate are slots to allow the actuating plate to be moved for a selected distance after having been turned and coupled to increase restrictive interference of the actuating plate against prying in an inverse direction.

5. The hinge fastening apparatus of claim 1, wherein the outer sleeve has at least two ratchet teeth of different directions formed on the outer surface thereof.

6. A hinge fastening apparatus comprising a cartridge fastening seat, an inner stem housed in an outer sleeve to run through the cartridge fastening seat and to be located on an installation side of the cartridge fastening seat, and an actuating plate located on an outer side of the cartridge fastening seat, wherein:
the cartridge fastening seat has flanges extended from two sides thereof, the flange on each side having an aperture;
the inner stem has a first pin hole on one end to pivotally couple with the actuating plate through a pin, and a straight stem section and a conical stem section;
the outer sleeve has annular teeth on an outer surface, slits formed on the peripheral wall, and a hollow interior which forms a straight bore section and a conical bore section; and
the actuating plate has second pin holes on an eccentric location of one end thereof to couple with the pin, the eccentric end forming a cam section; the actuating plate is bucking on an outer surface of the cartridge fastening seat in a tilted manner;
wherein the outer sleeve houses and couples the inner stem, the one end of the inner stem where the first pin hole is located running though the aperture to couple with the actuating plate outside the flange such that the coupling portion of the outer sleeve and the inner stem is located on an inner side of the flange.

7. The hinge fastening apparatus of claim 6, wherein the cam section has an inverse angle plane in contact with the flange so that the actuating plate forms the tilted manner.

8. The hinge fastening apparatus of claim 6, wherein the actuating plate has a force applying lever and a recess formed below the force applying lever to receive a hand tool for prying the actuating plate.

9. The hinge fastening apparatus of claim 6, wherein the second pin holes of the actuating plate are slots to allow the actuating plate to be moved for a selected distance after having been turned and coupled to increase restrictive interference of the actuating plate against prying in an inverse direction.

10. The hinge fastening apparatus of claim 6, wherein the outer sleeve has at least two ratchet teeth of different directions formed on the outer surface.
